(19) United States
(12) Patent Application Publication
(10) Pub. No.: US 2017/0231213 A1
(43) Pub. Date: Aug. 17, 2017

(54) PEST ABATEMENT UTILIZING AN AERIAL DRONE

(71) Applicant: International Business Machines Corporation, Armonk, NY (US)

(72) Inventors: MICHAEL S. GORDON, YORKTOWN HEIGHTS, NY (US); JAMES R. KOZLOSKI, NEW FAIRFIELD, CT (US); ASHISH KUNDU, ELMSFORD, NY (US); PETER K. MALKIN, ARDSLEY, NY (US); CLIFFORD A. PICKOVER, YORKTOWN HEIGHTS, NY (US)

(21) Appl. No.: 15/045,285

(22) Filed: Feb. 17, 2016

(51) Int. Cl. A01M 7/00; A01M 25/00; A01M 19/00; B64C 39/02; G05D 1/00

(52) U.S. Cl. CPC A01M 7/0089; B64C 39/024; G05D 1/0088; G05D 1/0038; A01M 19/00; A01M 25/00; B64C 2201/12; B64C 2201/127; A01M 2200/01

(57) ABSTRACT

An aerial drone includes a pest sensor, an environmental sensor, a drone on-board computer, and a pest abatement mechanism. The pest sensor senses a pest based on emissions from the pest. The environmental sensor detects an environment of the pest. The drone on-board computer identifies a pest type of the pest based on the emission from the pest, and establishes a risk level posed by the presence of the pest based on the pest type and the environment of the pest. The pest abatement mechanism performs a pest abatement of the pest based on the pest type and the risk level posed by the presence of the pest.

### BACKGROUND

The present disclosure relates to the field of aerial drones, and specifically to aerial drones that are capable of tracking pests. More specifically, the present disclosure relates to the user of an aerial drone to abate pests.

An aerial drone is an unmanned aircraft, also known as an unmanned aerial vehicle (UAV). That is, an aerial drone is an airborne vehicle that is capable of being piloted without an on-board human pilot. If autonomously controlled using an on-board computer and pre-programmed instructions, a UAV is called an autonomous drone. If remotely piloted by a human pilot, the UAV is called a remotely piloted aircraft (RPA).

### SUMMARY

In an embodiment of the present invention, an aerial drone-based method and/or computer program product abates a pest problem. A pest sensor on an aerial drone senses a pest, where the pest sensor detects an emission from the pest. One or more processors determine, based on sensor readings from environmental sensors on the aerial drone, an environment of the pest and identify a pest type of the pest based on the emission from the pest. The processor(s) establish a risk level posed by the presence of the pest based on the pest type and the environment of the pest. The aerial drone then initiates a pest abatement of the pest based on the pest type and the risk level posed by the presence of the pest.

In an embodiment of the present invention, an aerial drone includes a pest sensor, an environmental sensor, a drone on-board computer, and a pest abatement mechanism. The pest sensor senses a pest based on emissions from the pest. The environmental sensor detects an environment of the pest. The drone on-board computer identifies a pest type of the pest based on the emission from the pest, and establishes a risk level posed by the presence of the pest based on the pest type and the environment of the pest. The pest abatement mechanism performs a pest abatement of the pest based on the pest type and the risk level posed by the presence of the pest.

### BRIEF DESCRIPTION OF THE DRAWINGS

FIG. 1 depicts an exemplary system and network in which the present disclosure may be implemented;

FIG. 2 depicts additional detail of an exemplary aerial drone in accordance with one or more embodiments of the present invention;

FIG. 3 illustrates control hardware and other hardware features of an exemplary aerial drone in accordance with one or more embodiments of the present invention;

FIG. 4 depicts an aerial drone being utilized to control biological pests in accordance with one or more embodiments of the present invention;

FIG. 5 is a high-level flow chart of one or more steps performed by one or more computing and/or other hardware devices to ameliorate a pest problem in accordance with one or more embodiments of the present invention;

FIG. 6 depicts a cloud computing environment according to an embodiment of the present invention; and

FIG. 7 depicts abstraction model layers of a cloud computer environment according to an embodiment of the present invention.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

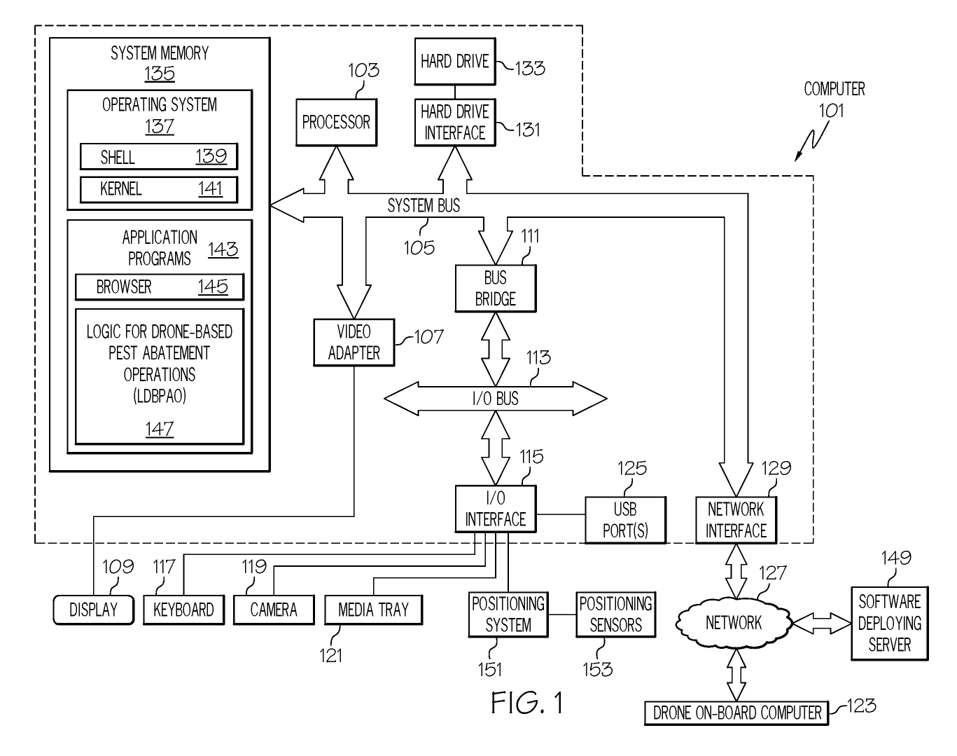

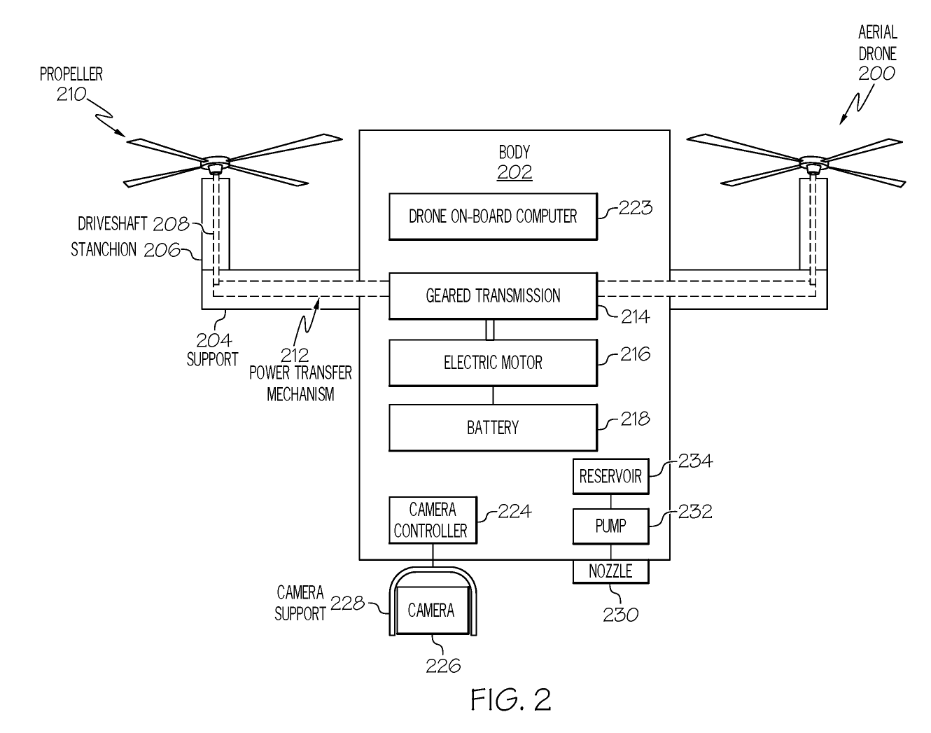

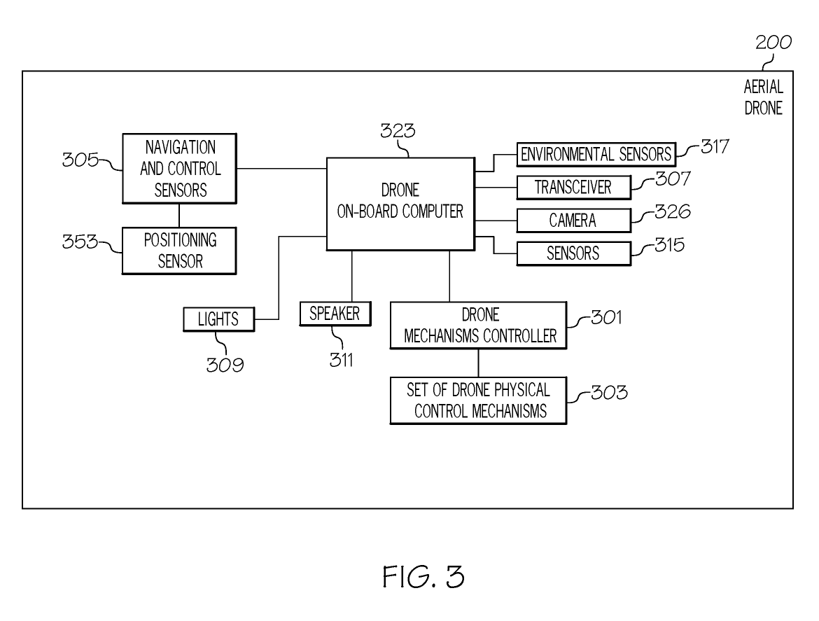

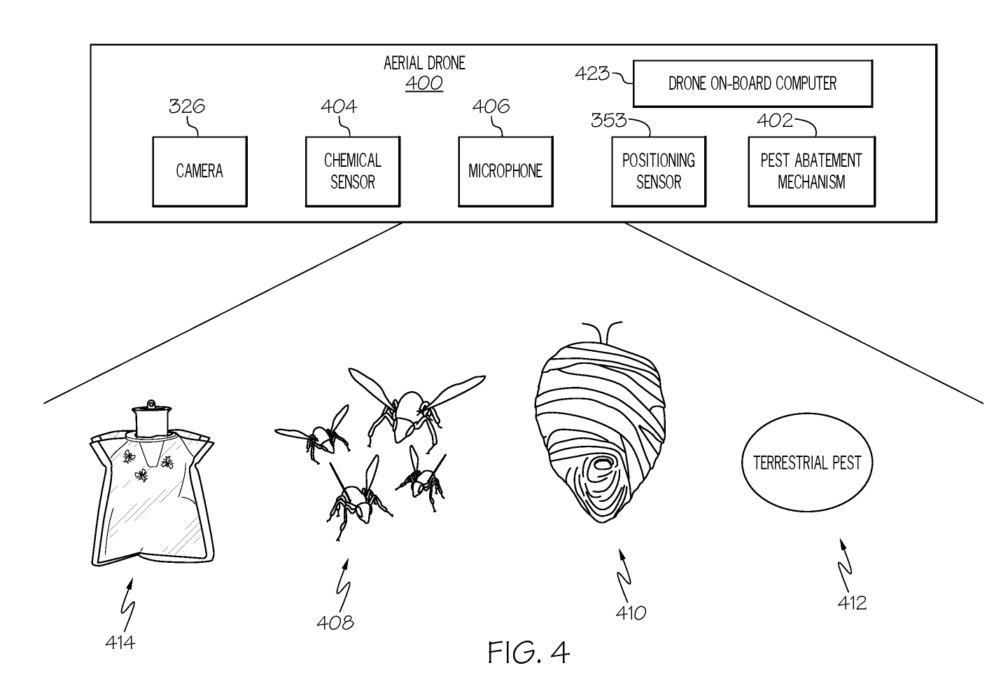

With reference now to the figures, and in particular to FIG. 1, there is depicted a block diagram of an exemplary system and network that may be utilized by and/or in the implementation of the present invention. Some or all of the exemplary architecture, including both depicted hardware and software, shown for and within computer 101 may be utilized by drone on-board computer 123 and/or software deploying server 149 and/or positioning system 151 shown in FIG. 1, and/or drone on-board computer 223 shown in FIG. 2, and/or drone on-board computer 323 shown in FIG. 3, and/or drone on-board computer 423 shown in FIG. 4.

Exemplary computer 101 includes a processor 103 that is coupled to a system bus 105. Processor 103 may utilize one or more processors, each of which has one or more processor cores. A video adapter 107, which drives/supports a display 109, is also coupled to system bus 105. System bus 105 is coupled via a bus bridge 111 to an input/output (I/O) bus 113. An I/O interface 115 is coupled to I/O bus 113. I/O interface 115 affords communication with various I/O devices, including a keyboard 117, a camera 119 (i.e., a digital camera capable of capturing still and moving images), a media tray 121 (which may include storage devices such as CD-ROM drives, multi-media interfaces, etc.), and external USB port(s) 125. While the format of the ports connected to I/O interface 115 may be any known to those skilled in the art of computer architecture, in one embodiment some or all of these ports are universal serial bus (USB) ports.

Also coupled to I/O interface 115 is a positioning system 151, which determines a position of computer 101 and/or other devices using positioning sensors 153. Positioning sensors 153, may be any type of sensors that are able to determine a position of a device, including computer 101, an aerial drone 200 shown in FIG. 2, etc. Positioning sensors 153 may utilize, without limitation, satellite based positioning devices (e.g., global positioning system—GPS based devices), accelerometers (to measure change in movement), barometers (to measure changes in altitude), etc.

As depicted, computer 101 is able to communicate with a software deploying server 149 and/or other devices/systems (e.g., drone on-board computer 123) using a network interface 129. Network interface 129 is a hardware network interface, such as a network interface card (NIC), etc. Network 127 may be an external network such as the Internet, or an internal network such as an Ethernet or a virtual private network (VPN). In one or more embodiments, network 127 is a wireless network, such as a Wi-Fi network, a cellular network, etc.

A hard drive interface 131 is also coupled to system bus 105. Hard drive interface 131 interfaces with a hard drive 133. In one embodiment, hard drive 133 populates a system memory 135, which is also coupled to system bus 105. System memory is defined as a lowest level of volatile memory in computer 101. This volatile memory includes additional higher levels of volatile memory (not shown), including, but not limited to, cache memory, registers and buffers. Data that populates system memory 135 includes computer 101's operating system (OS) 137 and application programs 143.

OS 137 includes a shell 139, for providing transparent user access to resources such as application programs 143. Generally, shell 139 is a program that provides an interpreter and an interface between the user and the operating system. More specifically, shell 139 executes commands that are entered into a command line user interface or from a file. Thus, shell 139, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 141) for processing. While shell 139 is a text-based, line-oriented user interface, the present invention will equally well support other user interface modes, such as graphical, voice, gestural, etc.

As depicted, OS 137 also includes kernel 141, which includes lower levels of functionality for OS 137, including providing essential services required by other parts of OS 137 and application programs 143, including memory management, process and task management, disk management, and mouse and keyboard management.

Application programs 143 include a renderer, shown in exemplary manner as a browser 145. Browser 145 includes program modules and instructions enabling a world wide web (WWW) client (i.e., computer 101) to send and receive network messages to the Internet using hypertext transfer protocol (HTTP) messaging, thus enabling communication with software deploying server 149 and other systems.

Application programs 143 in computer 101's system memory also include Logic for Drone-Based Pest Abatement Operations (LDBPAO) 147. LDBPAO 147 includes code for implementing the processes described below, including those described in FIGS. 2-5. In one embodiment, computer 101 is able to download LDBPAO 147 from software deploying server 149, including in an on-demand basis, wherein the code in LDBPAO 147 is not downloaded until needed for execution. In one embodiment of the present invention, software deploying server 149 performs all of the functions associated with the present invention (including execution of LDBPAO 147), thus freeing computer 101 from having to use its own internal computing resources to execute LDBPAO 147.

The hardware elements depicted in computer 101 are not intended to be exhaustive, but rather are representative to highlight essential components required by the present invention. For instance, computer 101 may include alternate memory storage devices such as magnetic cassettes, digital versatile disks (DVDs), Bernoulli cartridges, and the like. These and other variations are intended to be within the spirit and scope of the present invention.

FIG. 2 illustrates an exemplary aerial drone 200 in accordance with one or more embodiments of the present invention. The terms “aerial drone”, “drone”, and “unmanned aerial vehicle” (“UAV”) are used interchangeably herein to identify and describe an airborne vehicle that is capable of pilot-less flight and abating a pest problem as described herein.

As shown in FIG. 2, aerial drone 200 includes a body 202, which is attached to supports such as support 204. Supports such as support 204 support stanchions such as stanchion 206. Such stanchions provide a housing for a driveshaft within each of the stanchions, such as the depicted driveshaft 208 within stanchion 206. These driveshafts are connected to propellers. For example, driveshaft 208 within stanchion 206 is connected to propeller 210.

A power transfer mechanism 212 (e.g., a chain, a primary driveshaft, etc.) transfers power from a geared transmission 214 to the driveshafts within the stanchions (e.g., from geared transmission 214 to the driveshaft 208 inside stanchion 206), such that propeller 210 is turned, thus providing lift and steering to the aerial drone 200. Geared transmission 214 preferably contains a plurality of gears, such that a gear ratio inside geared transmission 214 can be selectively changed.

Power to the geared transmission 214 is preferably provided by an electric motor 216, which is quieter than an internal combustion engine, and thus is better suited to the present invention.

Affixed to the bottom of body 202 is a camera controller 224, which is logic that controls movement of a camera 226 via a camera support 228 (which includes actuators, not shown, for movement of camera 226). The camera controller 224 is able to focus, as well as aim camera 226, while under the control of a drone on-board computer 223 (analogous to drone on-board computer 123 shown in FIG. 1). In a preferred embodiment, drone on-board computer 223 controls all components of aerial drone 200 depicted in FIG. 2, and/or performs all or some of the analytics described herein (i.e., identifying a pest and/or pest type, abating a pest, etc.).

Also affixed to the body 202 of aerial drone 200 is a nozzle 230, which receives pumped material (by a pump 232) from a reservoir 234. In various embodiments of the present invention, the material stored in reservoir 234 is a powder, a liquid, or a slurry (i.e., a combination of liquid and powder).

While aerial drone 200 is depicted in FIG. 2 as having multiple propellers, in another embodiment a single propeller elevates and adjusts pitch and roll of the aerial drone while a rotor adjusts yaw of the aerial drone using a set of positioning sensors (e.g., gyroscopes) that cause the propeller and rotor to change attitude. Similar positioning sensors can likewise adjust the attitude of multiple propellers.

In an embodiment of the present invention, aerial drone 200 is “miniaturized”, thus allowing it to be flown in confined spaces, such as between walls, in attics, within silos, pressure vessels, and other storage structures, etc. That is, in this embodiment a maximum dimension of aerial drone 200 may be less than 6 inches, or even less than one inch, based on the level of available miniaturized components.

With reference now to FIG. 3, exemplary control hardware and other hardware components within the aerial drone 200 presented in FIG. 2 are depicted.

A drone on-board computer 323 (analogous to drone on-board computer 223 shown in FIG. 2) controls a drone mechanism controller 301, which is a computing device that controls a set of drone physical control mechanisms 303. The set of drone physical control mechanisms 303 include, but are not limited to, throttles for electric motor 216, selectors for selecting gear ratios within the geared transmission 214, controls for adjusting the pitch, roll, and angle of attack of propellers such as propeller 210 and other controls used to control the operation and movement of the aerial drone 200 depicted in FIG. 2.

Whether in autonomous mode or remotely-piloted mode (based on control signals sent via computer 101 to the drone on-board computer 123 shown in FIG. 1), the drone on-board computer 323 controls the operation of aerial drone 200. This control includes the use of outputs from navigation and control sensors 305 to control the aerial drone 200. Navigation and control sensors 305 include hardware sensors that (1) determine the location of the aerial drone 200; (2) sense pests and/or other aerial drones and/or obstacles and/or physical structures around aerial drone 200; (3) measure the speed and direction of the aerial drone 200; and (4) provide any other inputs needed to safely control the movement of the aerial drone 200.

With respect to the feature of (1) determining the location of the aerial drone 200, this is achieved in one or more embodiments of the present invention through the use of a positioning system such as positioning system 151 (shown in FIG. 1), which may be part of the drone on-board computer 323, combined with positioning sensor 353. Positioning system 151 may use a global positioning system (GPS), which uses space-based satellites that provide positioning signals that are triangulated by a GPS receiver to determine a 3-D geophysical position of the aerial drone 200. Positioning system 151 may also use, either alone or in conjunction with a GPS system, physical movement sensors such as accelerometers (which measure changes in direction and/or speed by an aerial drone in any direction in any of three dimensions), speedometers (which measure the instantaneous speed of an aerial drone), air-flow meters (which measure the flow of air around an aerial drone), barometers (which measure altitude changes by the aerial drone), etc. Such physical movement sensors may incorporate the use of semiconductor strain gauges, electromechanical gauges that take readings from drivetrain rotations, barometric sensors, etc.

With respect to the feature of (2) sensing pests and/or other aerial drones and/or obstacles and/or physical structures around aerial drone 200, the drone on-board computer 323 may utilize radar or other electromagnetic energy that is emitted from an electromagnetic radiation transmitter (e.g., transceiver 307 shown in FIG. 3), bounced off a physical structure (e.g., a pest, a swarm of pests, a building, bridge, another aerial drone, etc.), and then received by an electromagnetic radiation receiver (e.g., transceiver 307). By measuring the time it takes to receive back the emitted electromagnetic radiation, and/or evaluate a Doppler shift (i.e., a change in frequency to the electromagnetic radiation that is caused by the relative movement of the aerial drone 200 to objects being interrogated by the electromagnetic radiation) in the received electromagnetic radiation from when it was transmitted, the presence and location of other physical objects can be ascertained by the drone on-board computer 323.

With respect to the feature of (3) measuring the speed and direction of the aerial drone 200, this is accomplished in one or more embodiments of the present invention by taking readings from an on-board airspeed indicator (not depicted) on the aerial drone 200 and/or detecting movements to the control mechanisms (depicted in FIG. 2) on the aerial drone 200 and/or the positioning system 151 discussed above.

With respect to the feature of (4) providing any other inputs needed to safely control the movement of the aerial drone 200, such inputs include, but are not limited to, control signals to fly the aerial drone 200 to land aerial drone 200 (e.g., to make an emergency landing), etc.

Also on aerial drone 200 in one or more embodiments of the present invention is a camera 326, which is capable of sending still or moving visible light digital photographic images (and/or infrared light digital photographic images) to the drone on-board computer 323. Besides capturing images of pests as described herein, camera 326 is able to capture images of physical objects. These images can be used to determine the location of the aerial drone 200 (e.g., by matching to known landmarks), to sense other drones/obstacles, and/or to determine speed (by tracking changes to images passing by), as well as to receive visual images of pests as described herein.

Also on aerial drone 200 in one or more embodiments of the present invention are sensors 315. Examples of sensors 315 include, but are not limited to, air pressure gauges, microphones, barometers, chemical sensors, vibration sensors, etc., which detect a real-time operational condition of aerial drone 200 and/or an environment around aerial drone 200. Another example of a sensor from sensors 315 is a light sensor, which is able to detect light from other drones, street lights, home lights, etc., in order to ascertain the environment in which the aerial drone 200 is operating.

Also on aerial drone 200 in one or more embodiments of the present invention are lights 309. Lights 309 are activated by drone on-board computer 323 to provide visual warnings, alerts, etc. That is, once the aerial drone 200 detects a certain type of pest(s), an alert light (e.g., an intense flashing light) may be displayed by lights 309, warning persons of the proximity of the pest(s).

Also on aerial drone 200 in one or more embodiments of the present invention is a speaker 311. Speaker 311 is used by drone on-board computer 323 to provide aural warnings, alerts, etc. That is, once the aerial drone 200 detects a certain type of pest(s), an aural alert (e.g., an intense warning sound broadcast by speaker 311 on the aerial drone 200) may be sounded, warning persons of the proximity of the pest(s).

Also on aerial drone 200 in one or more embodiments of the present invention are environmental sensors 317, which sense an environment around a pest being monitored. Examples of environmental sensors 317 include, but are not limited to, cameras (that capture a visual image of an environment around a pest being tracked), chemical sensors (that capture ambient scents around the pest being tracked), microphones (that capture ambient sounds around the pest being tracked), positioning sensors (e.g., GPS-based devices that determine a geophysical location of the pest being tracked), etc.

With reference now to FIG. 4, an exemplary aerial drone 400 (analogous to aerial drone 200 shown in FIG. 2 and FIG. 3) is depicted in use according to one or more embodiments of the present invention.

Aerial drone 400 has a pest sensor, an environmental sensor, a drone on-board computer, and a pest abatement mechanism. As described herein, the pest sensor and the environmental sensor may be a same sensor, or may utilize different embodiments of a same depicted sensor.

For example, the pest sensor may be a combination of one or more of the camera 326, the chemical sensor 404 (i.e., a sensor hardware device capable of detecting airborne chemicals), and the microphone 406 depicted in FIG. 4. As such, this pest sensor is directed to a particular pest, such as airborne pests 408 (e.g., a swarm of wasps), or a terrestrial pest 412 (e.g., one or more rats or other rodents), and detects emissions from the pest. Examples of such emissions include, but are not limited to, light reflections (i.e., a visual image of the pest, pests spoor such as fecal droppings, broken foliage, trails, etc.), chemical emissions (i.e., pheromones, urine and feces odors), and/or sound emissions (vocalizations, movement sounds, etc.)

Similarly, the environmental sensor may be a combination of one or more of the camera 326, the chemical sensor 404, the microphone 406, and the positioning sensor 353 depicted in FIG. 4. As such, this environmental sensor is directed to an environment (i.e., the space surrounding the pest being monitored/tracked by the pest sensor) around the particular pest or a home of the pest, such as pest nest 410.

The drone on-board computer 423 identifies a pest type of the pest based on the emission from the pest, and also establishes a risk level posed by the presence of the pest based on the pest type and the environment of the pest.

Examples of pest abatement mechanism 402 include mechanical, chemical, aural, light, and other abatement mechanisms. For example, pest abatement mechanism 402 may be the combination of reservoir 234, pump 232, and nozzle 230 shown in FIG. 2 for spraying water, pesticide, etc. on the pest in order to disturb or kill the pest (e.g., airborne pests 408 or terrestrial pest 412). In another embodiment, pest abatement mechanism 402 is a mechanical probe (not shown in the figures) or merely the body 202 or propeller 210 or camera support 228 shown in FIG. 2 that can mechanically damage, knock off of an eave (in the case of a wasps' nest), etc. the pest nest 410. In another embodiment, the pest abatement mechanism 402 may be the propeller 210 shown in FIG. 2, which generates sufficient wind to blow a flying pest (e.g., airborne pests 408) out of an area. In another embodiment, the pest abatement mechanism 402 may be the lights 309 shown in FIG. 3, which can strobe brightly enough to cause pests (for example, bats) to vacate the area. In another embodiment, the pest abatement mechanism 402 may be the speaker 311 shown in FIG. 3, which emits a high pitched (e.g., above human hearing range) sound that causes the pest to leave the area.

For example, assume that the drone on-board computer 423, based on pest sensors, determines that the pest being monitored is a venomous insect having no useful agricultural purpose (e.g., a wasp but not a bee). Assume further that the wasp is identified as being next to a children's playground (and not in the middle of uninhabited woods). As such, the drone on-board computer 423 will determine that this wasp (or swarm of wasps) poses a threat to the children on the playground, and will take steps to abate (i.e., remove) the threat posed by the wasp(s).

Thus, the drone on-board computer 423 will initiate a pest abatement of the pest based on the pest type and the risk level posed by the presence of the pest. Examples of such pest abatement include killing the wasp(s) (e.g., by spraying a pesticide stored in the reservoir 234 shown in FIG. 2); physically forcing the wasp(s) to leave the area (e.g., by maneuvering the aerial drone 400 so close to the wasp(s) that they are encouraged to leave the area); spraying a non-toxic irritant at the wasp(s) (e.g., water from reservoir 234 that will annoy, but not kill, the wasp(s), thus encouraging them to leave the area); luring the wasp(s) to a trap (e.g., by applying a trail of attractive pheromones from reservoir 234 to a trap 414 that captures the wasp(s)); etc.

While the pests depicted in FIG. 4 represent terrestrial pests (e.g., wasps, rats, etc.), the present invention can also be utilized in abating aquatic pests, such as algae blooms, invasive species of fish, etc. For example, if aerial drone 400 detects an algae bloom (by camera 326 detecting a change to water color), then remedial steps can be implemented. Exemplary remedial steps include, but are not limited to, notifying a local environmental agency, applying (from pest abatement mechanism 402) a product that suppresses the algae bloom to the water, etc.

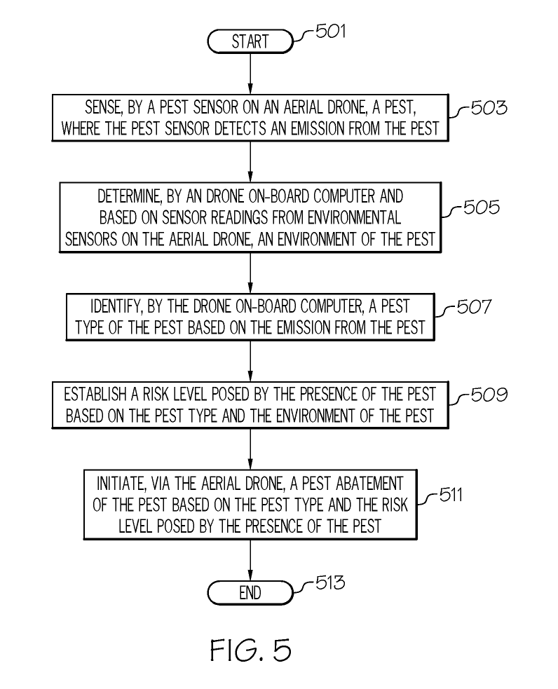

With reference now to FIG. 5, a high level flow chart of one or more steps performed by one or more processors and/or other hardware devices to abate the presence of a pest is presented. A pest is defined as any non-human biological creature predetermined to be unduly harmful (beyond a standard set by the entity making the predetermination) to persons, to domesticated animals, and/or to the environment. Such pests include, but are not limited to, venomous insects, rats, snakes, etc.

After initiator block 501, a pest sensor (e.g., camera 326, chemical sensor 404, microphone 406, etc. shown in FIG. 4) on an aerial drone (e.g., aerial drone 400 shown in FIG. 4) senses a pest (e.g., insect(s) such as airborne pests 408, vermin such as rats depicted in FIG. 4 as terrestrial pest 412, etc.), as described in block 503.

As described in block 505, a drone on-board computer (e.g., drone on-board computer 423 shown in FIG. 4), based on sensor readings from environmental sensors (e.g., camera 326, chemical sensor 404, microphone 406, positioning sensor 353 shown in FIG. 4) on the aerial drone determines an environment of the pest. This environment includes, but is not limited to, the geophysical location of the pest, organisms (e.g., crops, persons, pets, etc.) near the pest, designed purpose of the area around the pest (e.g., a playground versus a factory versus an isolated forest), a specific part of a house (e.g., the attic, backyard, garage, etc.), etc.

As described in block 507, the drone on-board computer identifies a pest type of the pest based on the emission from the pest. This emission may be visual (i.e., light reflected off the pest—i.e., a visual image), chemical (e.g., scents of pheromones, urea, feces, etc. coming off the pest), auditory (e.g., vocalizations or movement sounds generated by the pest), etc. The drone on-board computer digitizes such sensor readings of the pest emissions, and compares the digitized sensor readings with a database of known types of pests in order to identify the pest currently being tracked.

As described in block 509, the drone on-board computer establishes a risk level posed by the presence of the pest based on the pest type and the environment of the pest. That is, the drone on-board computer may enter keywords such as “wasp” and “playground” into a lookup table. The lookup table would then return a value of “High risk level” based on these inputs.

As described in block 511, the aerial drone utilizes the pest abatement mechanism 402 shown in FIG. 4 to initiate a pest abatement of the pest based on the pest type and the risk level posed by the presence of the pest. This pest abatement may be to kill the pest, to force the pest to move to another location, to lure the pest to a trap, etc. as described herein.

The flow chart ends at terminator block 513.

Thus, in an embodiment of the present invention, the pest sensor is a camera (e.g., camera 326), and the emission from the pest is a visual image of the pest (i.e., light being reflected off the pest and captured by the camera), such that the visual image of the pest is captured by the camera.

In an embodiment of the present invention, the visual image of the pest captured by the camera is transmitted from the aerial drone to a display used by a user. For example, a user may be using computer 101 shown in FIG. 1. The drone on-board computer 123 shown in FIG. 1 will transmit (e.g., stream in real time) images of the pest to the user, thus allowing the user to be part of the abatement process.

For example, in an embodiment of the present invention, authorization from the user to complete the pest abatement must be received by the aerial drone before completing the pest abatement. Thus, the user will send an authorization code from the computer 101 to the drone on-board computer 123 1) to authorize the pest abatement mechanism 402 to abate the pest problem (e.g., by killing the pest, chasing the pest away, luring the pest to a trap, etc.), and/or 2) to select which type of pest abatement is used (kill, chase, lure, etc.).

In an embodiment of the present invention, the pest sensor is a chemical sensor, and the emission from the pest is a pheromone indicative of a state of the pest. For example, certain types of wasps emit a first type of pheromone when they are merely foraging for food, and a second type of pheromone when they are prompted to aggression. As such, different types of abatement are appropriate. That is, if the wasps are merely foraging for food, then they could be sprayed with water from reservoir 234 (shown in FIG. 2) in order to encourage them to leave the area. However, if they are already in an aggressive and thus dangerous state, then they would be killed by spraying insecticide from reservoir 234. Thus, the chemical sensor on the aerial drone detects the pheromone being emitted from the pest, and the aerial drone adjusts the type of pest abatement performed by the pest abatement mechanism based on the pheromone being emitted from the pest.

In an embodiment of the present invention, the pest sensor is a microphone (e.g., microphone 406 shown in FIG. 4), and the emission from the pest is a sound generated by the pest (e.g., a vocalization such as squeaking by a rat, noise movement such as the buzz of wasps' wings, etc.). In such an embodiment, the drone on-board computer classifies a sound type of the sound being picked up. The sound type is associated with a particular type of pest behavior. For example, one type of rat vocalization may indicate normal foraging, while another type of rat vocalization may indicate intense aggression. As such, the drone on-board computer will direct the pest abatement mechanism to adjust the pest abatement of the pest based on the sound type of the sound generated by the pest.

In an embodiment of the present invention, a camera (e.g., camera 326 shown in FIG. 3) on the aerial drone detects a pest nest (e.g., pest nest 410 shown in FIG. 4) of the pest. In response to detecting the pest nest, the pest abatement mechanism (pest abatement mechanism 402) destroys the pest nest using mechanical or chemical means (described above).

In an embodiment of the present invention, a pesticide dispenser (e.g., a combination of reservoir 234, pump 232, and nozzle 230 shown in FIG. 2) performs the pest abatement by applying pesticide to the pest.

In an embodiment of the present invention, a chemical lure dispenser (e.g., a combination of reservoir 234, pump 232, and nozzle 230 shown in FIG. 2) performs the pest abatement by applying a trail of chemical lure to a pest trap.

In an embodiment of the present invention, the pest is one or more insects from a group of insects consisting of wasps, hornets, scorpions, locusts, carpenter ants, termites, cockroaches, ticks, and yellow jackets.

In an embodiment of the present invention, the pest is one or more mammals from a group of mammals consisting of mice, rats, opossums, and skunks.

In an embodiment of the present invention, the pest is one or more reptiles from a group of reptiles consisting of snakes, lizards, venomous toads, etc.

In an embodiment of the present invention, the pest is an insect that is part of an insect swarm (e.g., the depicted airborne pests 408 shown in FIG. 4). In this embodiment, the aerial drone-based method may further detect, by the aerial drone, a behavioral pattern of insect swarm, where the behavioral pattern includes insect swarming movement indicative of aggressive behavior, insect swarm density changes, and flight patterns of the insect swarm towards a pest nest. The aerial drone will then adjust the pest abatement according to the behavioral pattern of the insect swarm. That is rather than just comparing the movement, pheromones, etc. of a single flying insect, this embodiment evaluates the movement, pheromones, etc. of an entire swarm of flying insects. Such swarms have characteristic shapes, movement, etc. that are compared to known swarm traits, in order to determine if the swarm if in an aggressive attack mode, is merely flying back to their hive, is merely foraging for food, etc. Based on this determination, the type of pest abatement is adjusted accordingly.

Thus, described in various embodiments herein is a method and system that includes and/or utilizes a smart flying drone with image capture and analysis capabilities and a means for insect identification (ID) estimation (i.e. insect identification, insect behavior identification, and/or hive identification). Based on these means of ID estimation and risk estimation, a pest abatement mechanism for pest extermination or amelioration is triggered.

One benefit of the invention presented herein is that a human is less likely to be stung or otherwise be adversely affected, as may be the case if a human must climb a ladder to reach a pest nest (e.g., a wasp nest). Also, the present invention allows insect extermination in hard-to-reach places, such as crawl spaces, between walls, in tight attics, in confined spaces such as storage silos and storage tanks, etc.

The smart drone presented herein can also ensure that a pesticide residue or application does not exceed a standard. Therefore, the environment is less likely to be polluted, and an operator is less likely to be poisoned.

Furthermore, in one embodiment, the smart flying drone is a tiny drone with a camera that can scout for insects and hives within the wall of a home or business.

The images taken by the aerial/flying drone optionally may be relayed to a drone operator and/or stored for historical information or other purposes.

As described herein, a means of risk R determination may be employed (e.g., possible danger to home, humans, or pets). For example, some insects are more dangerous than others. Asian giant hornets have one of the most venomous stings recorded, and like other types of hornets/wasps, they can sting multiple times, thus making them particularly dangerous. Thus, when the presently described system detects such dangerous pests, special care (e.g., immediate spraying with a pesticide) is taken.

The risk R determination can also include an estimate of the type and numbers of insects, a size of a nest (indicating how many pests are in the area), a time of day (e.g., most insects tend to be more docile at night than in the daytime, and thus, different abatement procedures are implemented at night as compared to the daytime), swarming behavior, etc.

The means of extermination may include insecticide (e.g. spray), mechanical destruction, trapping, or luring to a trap using an insect attractant, etc. as described herein.

In an embodiment of the present invention, before a drone takes an extermination action, it must wait for confirmation from a human operator and/or enlist other drones to increase confidence levels and when such other drones have appropriate extermination features. For example, assume that a particular aerial drone has a 70% confidence level that a pest swarm being observed warrants being sprayed with a pesticide from that aerial drone, and that there is a 50% chance that the particular aerial drone spraying the swarm will eradicate it. In order to increase these confidence levels, this first aerial drone will call for (i.e., send a message to other aerial drones in the area) other aerial drones to come to where the first aerial drone is in order to 1) confirm the type and state of insects in the swarm, and 2) assist the first aerial drone in the spraying operations, in order to wipe out the swarm.

In an embodiment of the present invention, the aerial drone has a means of tracking (e.g., following) insects, in order to find a nest or area of ingress to a home through a hole. For example, the aerial drone may wait until dusk, when many types of inspects return to their nests, and then follow the insects as they fly to a hole in a building, a tree or the ground (e.g., for ground wasps). Alternately, the aerial drone may wait until daybreak to track the return of nocturnal animals to attics or eaves (e.g., for bats) or other locations such as trees or burrows. The aerial drone may also be programmed to follow a concentration gradient of insects towards areas of highest concentration (e.g., the nest).

In some cases, the drone may seek to identify helpful insects (e.g., honeybees needed for pollination). In such cases, the drone may take a helpful action such as “doing no harm”, providing food or water, discouraging predators and parasites, etc. That is, many pests feed on the bees themselves, bee brood (for protein), sugar/corn syrup or pollen patties. The chances of these pests attacking hives are higher when food is scarce or when there are large apiaries of 40 or more hives. Thus, the drone may spray food for the pests, in order to remove the motivation to attack the bee hives.

When the drone finds and/or exterminates a pest nest (e.g., a wasp nest), it may optionally convey a signal to neighbors, farmers, etc. about possible dangers, to be alert for possible reoccurrence, and/or to inform them the job is done. That is, if the drone is spraying pesticide, a signal may be sent to cell phones within a certain area warning the users of the cell phones that pesticide spraying is occurring in the area.

In an embodiment of the present invention, the use of the aerial drone reduces the possibility of polluting certain locations, like a nearby water supply. In this embodiment, the drone's sensors detect pests and/or pest nests near an environmentally sensitive area (e.g., a reservoir, or the location of an endangered animal/plant species). Before a drone takes an extermination action near an environmentally sensitive area, it must request confirmation from a human operator, or refer to data regarding the environmentally sensitive area to discover whether pest abatement is allowed. If it is predetermined that certain levels of pesticide will have no adverse effects on the environmentally sensitive area, the drone may move forward with the extermination action. If it is determined that a higher level of pesticide is needed, but cannot be allowed, the drone may employ an alternate, non-polluting form of pest abatement.

A high-definition camera, an image processor, and a main controller may be employed for insect analysis, hive analysis, etc. The image processor may be connected with the high-definition camera and used for performing picture processing on the potential insect/hive/swarming pictures to obtain pest types. If desired, according to this pest detecting system, the pest types can be automatically obtained to provide convenience for relevant agricultural management departments (or homeowners or exterminators) to invoke during returning of the unmanned aerial vehicle, so that pointed pest prevention and control measurements can be made. Alternatively, the drone can be smart and take action.

In some embodiments, an attractant (referred to as a “lure” herein) is used to attract pests. As just one example, the composition may include a volatile insect attractant chemical blend comprising acetic acid and one or more compounds selected from the short chain alcohol group chosen from among methyl-1-butanol, isobutanol, and 2-methyl-2-propanol; and one or more homo- or mono-terpene herbivore-induced plant volatiles chosen from among (E)-4,8-dimethyl-1,3,7-nonatriene, (Z)-4,8-dimethyl-1,3,7-nonatriene, 4,8,12-trimethyl-1,3E,7E,11-tridecatetraene, trans-β-ocimene, ds-P-ocimene, iraws-a-ocimene, ds-a-ocimene, and any combination thereof. The composition may be useful to attract one or more insect species, including, but not limited to, wasps, hornets, and yellowjackets, to a location or trap.

Insect identification can be performed by one or more means. For example, insects may be identified by digital image progressing, pattern recognition and the theory of taxonomy. Artificial neural networks (ANNs) and a support vector machine (SVM) are used as pattern recognition methods for the identifications. Similarly, other input parameters may be considered such as body shape and pattern characteristics, body eccentricity, color complexity, center of gravity of insect silhouette, etc. For example, a sample image (taken in real time of a pest) and a recognition image (of a known pest) may be input into a preprocess image, which contains common features of both images (e.g., size, color, shape, etc. of the pest). The common features are extracted in order to 1) recognize the type of pest, and 2) train the system to look for certain features in future pests, in order to recognize future presences of the pest.

Also, for some insect groups, wing outline can be used species identification. Thus the drone presented herein may employ a program as the integral part of an automated system to identify insects based on wing outlines. This program includes two main functions: 1) outline digitization and Elliptic Fourier transformation, and 2) classifier model training by pattern recognition of support vector machines and model validation.

The present invention may be implemented in one or more embodiments using cloud computer. Nonetheless, it is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

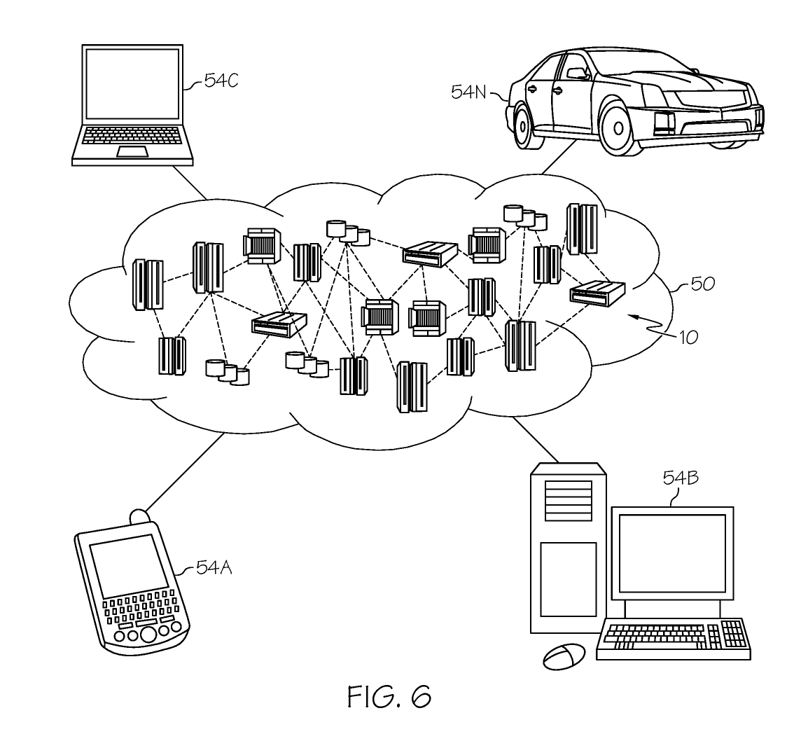

Referring now to FIG. 6, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-54N shown in FIG. 6 are intended to be illustrative only and that computing nodes 10 and cloud computing environment 50 can communicate with any type of computerized device over any type of network and/or network addressable connection (e.g., using a web browser).

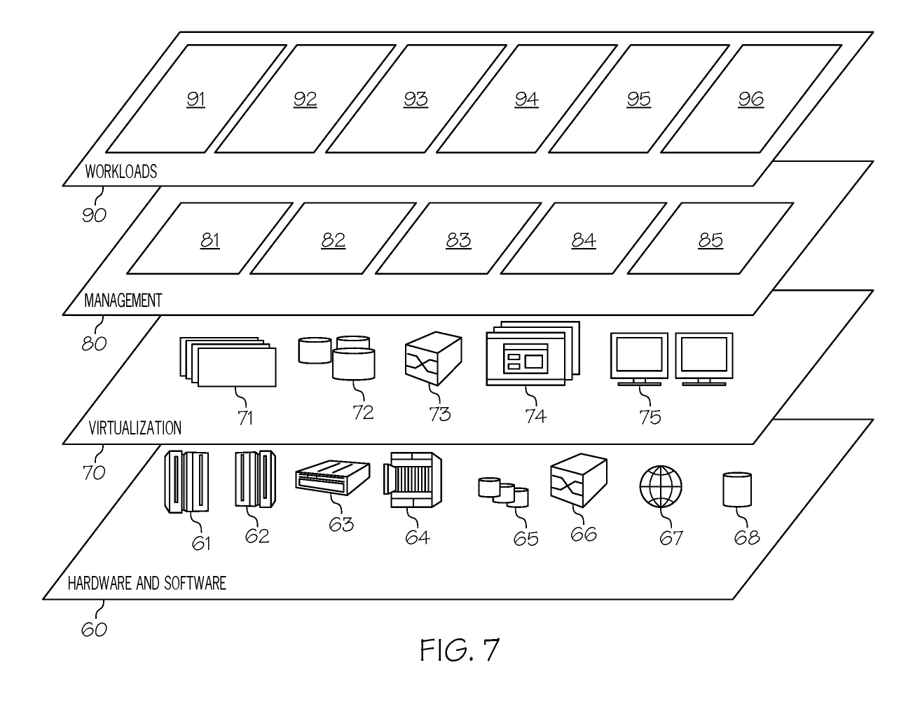

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and drone control processing 96.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the present invention in the form disclosed. Many modifications and variations will be apparent to those of ordinary skill in the art without departing from the scope and spirit of the present invention. The embodiment was chosen and described in order to best explain the principles of the present invention and the practical application, and to enable others of ordinary skill in the art to understand the present invention for various embodiments with various modifications as are suited to the particular use contemplated.

Any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the present invention of the present application in detail and by reference to illustrative embodiments thereof, it will be apparent that modifications and variations are possible without departing from the scope of the present invention defined in the appended claims.

What is claimed is:

1. An aerial drone-based method of pest abatement, the aerial drone-based method comprising:
sensing, by a pest sensor on an aerial drone, a pest, wherein the pest sensor detects an emission from the pest;
determining, by one or more processors and based on sensor readings from environmental sensors on the aerial drone, an environment of the pest;
identifying, by one or more processors, a pest type of the pest based on the emission from the pest;
establishing, by one or more processors, a risk level posed by a presence of the pest based on the pest type and the environment of the pest; and
initiating, via the aerial drone, a pest abatement of the pest based on the pest type and the risk level posed by the presence of the pest.

2. The aerial drone-based method of claim 1, wherein the pest sensor is a camera, wherein the emission from the pest is a visual image of the pest, and the visual image of the pest is captured by the camera.

3. The aerial drone-based method of claim 2, further comprising:
transmitting, from the aerial drone to a display used by a user, the visual image of the pest.

4. The aerial drone-based method of claim 3, further comprising:
receiving, by the aerial drone, an authorization from the user to complete the pest abatement; and
in response to receiving the authorization from the user, completing the pest abatement.

5. The aerial drone-based method of claim 1, wherein the pest sensor is a chemical sensor, wherein the emission from the pest is a pheromone indicative of a state of the pest, and wherein the aerial drone-based method further comprises:
detecting, by the chemical sensor on the aerial drone, the pheromone being emitted from the pest; and
adjusting, by the aerial drone, the pest abatement based on the pheromone being emitted from the pest.

6. The aerial drone-based method of claim 1, wherein the pest sensor is a microphone, wherein the emission from the pest is a sound generated by the pest, and wherein the aerial drone-based method further comprises:
classifying, by one or more processors, a sound type of the sound, wherein the sound type is associated with a particular type of pest behavior; and
adjusting, by one or more processors, the pest abatement of the pest based on the sound type of the sound generated by the pest.

7. The aerial drone-based method of claim 1, further comprising:
detecting, by a camera on the aerial drone, a pest nest of the pest; and
in response to detecting the pest nest, destroying, by the pest abatement mechanism, the pest nest.

8. The aerial drone-based method of claim 1, further comprising:
performing, by a pesticide dispenser, the pest abatement by applying pesticide to the pest.

9. The aerial drone-based method of claim 1, further comprising:
performing, by a chemical lure dispenser, the pest abatement by applying a trail of chemical lure to a pest trap.

10. The aerial drone-based method of claim 1, wherein the pest is one or more insects from a group of insects consisting of wasps, hornets, scorpions, locusts, carpenter ants, termites, cockroaches, ticks, and yellow jackets.

11. The aerial drone-based method of claim 1, wherein the pest is one or more mammals from a group of mammals consisting of mice, rats, opossums, and skunks.

12. The aerial drone-based method of claim 1, wherein the pest is a reptile.

13. The aerial drone-based method of claim 1, wherein the pest is an insect that is part of an insect swarm, and wherein the aerial drone-based method further comprises:
detecting, by the aerial drone, a behavioral pattern of the insect swarm, wherein the behavioral pattern includes insect swarming movement indicative of aggressive behavior, insect swarm density changes, and flight patterns of the insect swarm towards a pest nest; and
adjusting, by the aerial drone, the pest abatement according to the behavioral pattern of the insect swarm.

14. A computer program product for abating pests by an aerial drone, the computer program product comprising a non-transitory computer readable storage medium having program code embodied therewith, the program code readable and executable by a processor to perform a method comprising:
sensing, by a pest sensor on an aerial drone, a pest, wherein the pest sensor detects an emission from the pest;
determining, by a drone on-board computer and based on sensor readings from environmental sensors on the aerial drone, an environment of the pest;
identifying, by the drone on-board computer, a pest type of the pest based on the emission from the pest;
establishing a risk level posed by a presence of the pest based on the pest type and the environment of the pest; and
initiating, via the aerial drone, a pest abatement of the pest based on the pest type and the risk level posed by the presence of the pest.

15. The computer program product of claim 14, wherein the pest sensor is a chemical sensor, wherein the emission from the pest is a pheromone indicative of a state of the pest, and wherein the method further comprises:
detecting, by the chemical sensor on the aerial drone, the pheromone being emitted from the pest; and
adjusting, by the aerial drone, the pest abatement based on the pheromone being emitted from the pest.

16. The computer program product of claim 14, wherein the method further comprises:
detecting, by a camera on the aerial drone, a pest nest of the pest; and
in response to detecting the pest nest, destroying, by the pest abatement mechanism, the pest nest.

17. The computer program product of claim 14, wherein the method further comprises:
performing, by a chemical lure dispenser, the pest abatement by applying a trail of chemical lure to a pest trap.

18. The computer program product of claim 14, wherein the pest is an insect that is part of an insect swarm, and wherein the method further comprises:
detecting, by the aerial drone, a behavioral pattern of the insect swarm, wherein the behavioral pattern includes insect swarming movement indicative of aggressive behavior, insect swarm density changes, and flight patterns of the insect swarm towards a pest nest; and
adjusting, by the aerial drone, the pest abatement according to the behavioral pattern of the insect swarm.

19. An aerial drone comprising:
a pest sensor, wherein the pest sensor senses a pest, wherein the pest sensor detects an emission from the pest;
an environmental sensor, wherein the environmental sensor detects an environment of the pest;
a drone on-board computer, wherein the drone on-board computer:
identifies a pest type of the pest based on the emission from the pest; and
establishes a risk level posed by a presence of the pest based on the pest type and the environment of the pest; and
a pest abatement mechanism, wherein the pest abatement mechanism performs a pest abatement of the pest based on the pest type and the risk level posed by the presence of the pest.

20. The aerial drone of claim 19, wherein the pest sensor is a chemical sensor, wherein the emission from the pest is a pheromone indicative of a state of the pest, and wherein the pest abatement mechanism performs a particular pest abatement specifically designed for the state of the pest.
